(19) United States
(12) Patent Application Publication
(10) Pub. No.: US 2009/0007082 A1
(43) Pub. Date: Jan. 1, 2009

(54) Method for the Translation of a Subprogram by an Interpreter in a Control Device

(75) Inventor: Joachim Nebel, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, MUNCHEN (DE)

(21) Appl. No.: 11/817,063

(22) PCT Filed: Feb. 21, 2006
(86) PCT No.: PCT/EP06/60155

§ 371 Date: May 6, 2008

(30) Foreign Application Priority Data
Feb. 24, 2005 (DE) 10-2005-008-500.8

(51) Int. Cl. G06F 9/45

(52) U.S. Cl. 717/139

(57) ABSTRACT

The invention relates to a method for the translation of a sub-programme (2) by an interpreter (5) in a control device (4) for the control of a machine tool, production machine and/or a robot, whereby the sub-programme (2) comprises a number of process blocks which are serially read by the interpreter (5). On reading a process block by the interpreter (5), defined as a pattern instruction by graphical information and containing structure information on the data format of subsequent process blocks, a form (8), comprising said data format is generated by the interpreter (5) and stored and the parameters for a process block subsequently read by the interpreter (5) are entered on the form (8) and, similarly, a data set (9) is generated from the form (8) and the parameters of the process block. The invention relates to a corresponding control device. By means of the above, a simple rapid method for the interpretation of a sub-programme by an interpreter in a control device for the control of a machine tool, production machine and/or a robot and a corresponding control device are achieved.

The invention relates to a method for the translation of a subprogram by an interpreter in a control device for controlling a machine tool, a production machine and/or a robot.

The invention also relates to a relevant control device for controlling a machine tool, a production machine and/or a robot.

In the case of control devices for machine tools, production machines and/or robots, for example, the machining process for a workpiece to be machined is described in a so-called subprogram which is read in by the control device for controlling the machine. Each subprogram comprises a multiplicity of machining blocks which define the machining process. Subprograms of this type are nowadays usually created in a CAD system and often comprise several thousand machining blocks whose structure is often always the same. Only the parameters needed for machining change very often from machining block to machining block.

The conventionally used control devices for controlling the machine operate with an interpreter, that is to say each individual machining block is individually translated by the interpreter. In this case, translation means converting the ASCII characters of the machining block, checking the syntax of the machining block, checking the programming rules of the machining block and generating an associated data record in a defined data format. The data record is then read in by an interpolator of the control device, which uses the data record to generate desired values for a drive of the machine.

The disadvantage of this method is that unnecessary computation time is used when the interpreter is translating the machining blocks on account of the large amount of redundant data in the subprogram.

Furthermore, the subprograms are often also so large that they do not fit in the memory of the control device and therefore have to be loaded in sections from an external computer into the memory of the control device during their execution. Since the conventionally used bus connection between the external computer and the control device has only a limited transmission capacity, the interpreter often cannot be provided with the machining blocks at the required speed.

The abovementioned disadvantages give rise to a reduced machining speed and/or a poorer surface quality of a workpiece to be machined by the machine.

Conventionally, an attempt has hitherto been made to shorten the computation time with the aid of faster hardware.

However, this solution is complicated and expensive.

The invention is based on the object of providing a simple and fast method for the translation of a subprogram by an interpreter in a control device for controlling a machine tool, a production machine and/or a robot. Furthermore, the intention is also to provide a relevant control device.

This object is achieved by means of a method for the translation of a subprogram by an interpreter in a control device for controlling a machine tool, a production machine and/or a robot, the subprogram having a multiplicity of machining blocks which are successively read in by the interpreter, in which case, if the interpreter reads in a machining block which is defined as a pattern instruction by an item of graphical information and contains structure information relating to the data format of subsequent machining blocks, a form having this data format is generated and stored by the interpreter, and the parameters of a subsequent machining block which is read in by the interpreter are entered in the form, and a data record is generated from the form and the parameters of the machining block in such a manner.

Furthermore, this object is achieved by means of a control device for controlling a machine tool, a production machine and/or a robot, said control device comprising a subprogram and an interpreter, the subprogram having a multiplicity of machining blocks which are successively read in by the interpreter, the interpreter being designed in such a manner that, if the interpreter reads in a machining block which is defined as a pattern instruction by an item of graphical information and contains structure information relating to the data format of subsequent machining blocks, a form having this data format is generated and stored by the interpreter, and the parameters of a subsequent machining block which is read in by the interpreter are entered in the form, and a data record is generated from the form and the parameters of the machining block in such a manner.

It proves to be advantageous for the machining block to contain a work instruction and a parameter. It represents the conventional form of a machining block.

It also proves to be advantageous for the parameters of a subsequent machining block which is read in by the interpreter, is defined as belonging to the pattern instruction by a further item of graphical information and has only parameters to be entered in the form. A further item of graphical information can be used to define machining blocks as belonging to a particular pattern instruction.

Any desired number of machining blocks can thus be permanently assigned to each pattern instruction.

Furthermore, it proves to be advantageous for a parameter to be in the form of a special character since the number of data items to be translated can then be reduced even further.

Advantageous designs of the control device emerge in an analogous manner to the advantageous designs of the method and vice versa.

One exemplary embodiment of the invention is illustrated in the drawing and is explained in more detail below. In the drawing:

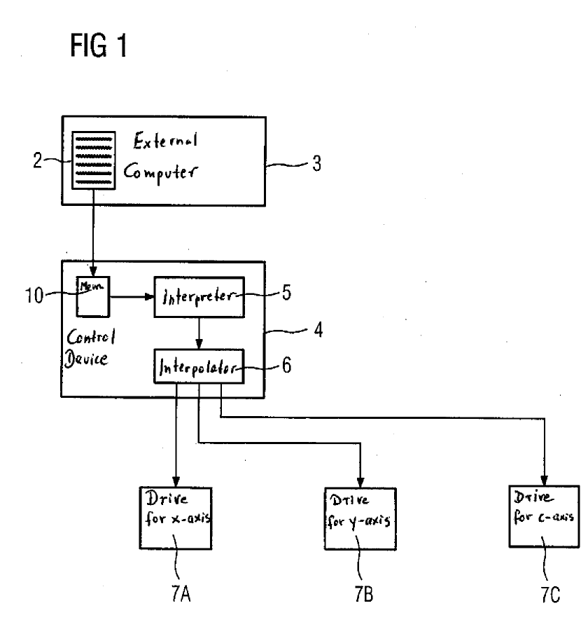

FIG. 1 shows a control device,

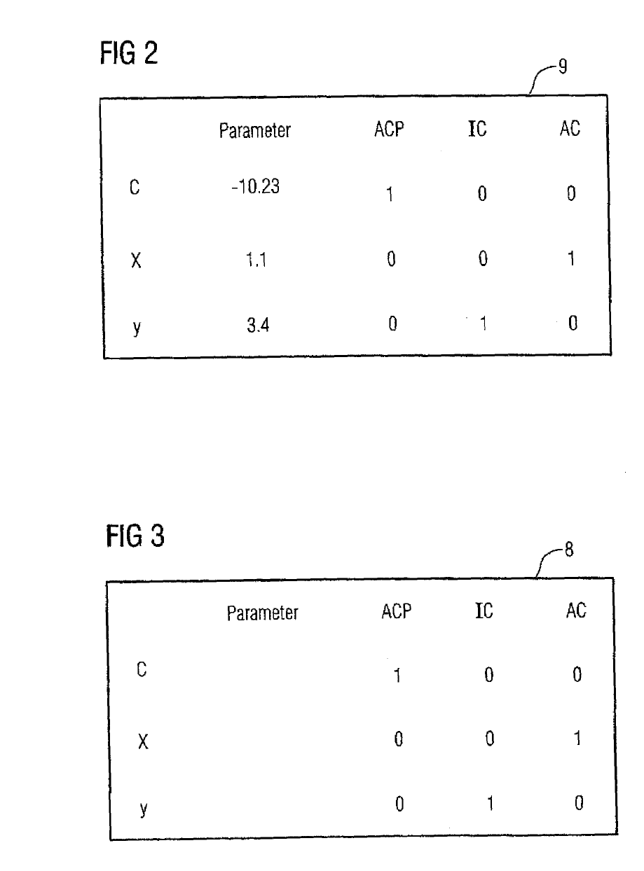

FIG. 2 shows a data record, and

FIG. 3 shows a form.

FIG. 1 illustrates the fundamental control components of a machine, for example a machine tool, a production machine and/or a robot, in the form of a block diagram.

A plurality of subprograms for machining workpieces are stored in an external computer 3 which is conventionally generally in the form of a personal computer and is essentially used to operate the machine, only one subprogram 2 being illustrated in FIG. 1 for the sake of clarity. Each subprogram comprises a multiplicity of successive machining blocks which are indicated in FIG. 1 by jagged lines inside the illustration of the subprogram 2. Within the scope of the exemplary embodiment, it shall be assumed below that the subprogram comprises the machining blocks A, B, C and D below.

C=ACP(−10.23) X1.1 Y=IC(3.4) (A)

C=ACP(−20.23) X2.1 Y=IC(4.8) (B)

Y=IC(5.1) (C)

C=ACP(−22.23) X3.3 Y=IC(2.9) (D)

Each machining block contains work instructions and corresponding parameters which indicate, for example, the manner in which the axles of the machine need to be moved, each machining block generally being successively executed. If, for example, the machining block A is considered, the work instruction C=ACP in conjunction with the parameter −10.23 means that the C axle of the machine should be rotated in the positive direction to the value −10.23. The work instruction X in conjunction with the parameter 1.1 means that the X axle of the machine should be moved to the position 1.1. The work instruction Y=IC in conjunction with the parameter 3.4 means that the Y axle should be moved from the current position by the value of 3.4.

In the exemplary embodiment, each work instruction is allocated only one individual parameter. However, depending on the type of work instruction, a plurality of parameters may also belong to a work instruction. The structure of the machining blocks B and D is designed in a manner corresponding to that of the machining block A. The machining block C has a structure which differs from this.

At the beginning of the operation of machining a workpiece, the subprogram needed for this purpose is downloaded from the external computer 3, if this is possible in terms of its size, to a memory 10 of a control device 4 for controlling a machine tool, a production machine and/or a robot, which is indicated by a corresponding arrow in FIG. 1. If the subprogram 2 is too large for the memory 10, only part of the subprogram can first of all also be loaded into the memory 10 and the remaining parts of the subprogram 2 can be correspondingly downloaded during the machining operation.

The external computer 3 and the control device 4 are generally connected to one another by means of a bus connection for the purpose of interchanging data.

The individual machining blocks of the subprogram 2 are then successively translated by an interpreter 5 and a corresponding data record for an interpolator 6 is generated for each machining block. In this case, the ASCII characters of the machining blocks are converted, the syntax of the machining blocks is checked and the programming rules of the machining blocks are checked during translation by the interpreter. On the basis of the data record generated by an interpreter, an interpolator 6 calculates desired axle values as input variables for the drives 7A, 7B and 7C for moving the corresponding axles X, Y and C of the machine. In this case, in the exemplary embodiment, the drive 7A drives the X axle, the drive 7B drives the Y axle and the drive 7C drives the C axle.

According to the invention, a special machining block is then defined in the subprogram as a so-called pattern instruction with the aid of an item of graphical information. This definition is preferably made at the start of the subprogram. The pattern instruction itself no longer contains any parameters but rather only structure information relating to the data format of subsequent machining blocks which are defined as belonging to the pattern instruction by a further item of graphical information and have only parameters.

In accordance with the machining blocks A, B, C and D above, the subprogram used for the method according to the invention is then as follows:

DEFPATT C=ACP(REAL) X(REAL) Y=IC(Real) (P)

&−10.23,1.1,3.4 (A*)

&−20.23,2.1,4.8 (B*)

Y=IC(5.1) (C*)

&−22.23,3.3,2.9 (D*)

At the beginning of the subprogram which is adopted here within the scope of the exemplary embodiment, the pattern instruction P is used to define the data format of subsequent machining blocks which are read in by the interpreter and are defined as belonging to the pattern instruction by a further item of graphical information. In the exemplary embodiment, the ASCII character string “DEFPATT” forms the item of graphical information for defining the machining block as a pattern instruction. The further item of graphical information “&” in some of the subsequent machining blocks defines that they belong to the pattern instruction above. These are the machining blocks A*, B* and D* in the exemplary embodiment. The pattern instruction P then contains structure information relating to the data format of the subsequent machining blocks which have been labeled with “&”. For example, it is thus defined that the parameter −10.23 of the machining block A* should be interpreted as a real number and the C axle should be moved in the clockwise direction to the position −10.23 in accordance with the work instruction C=ACP. The machining block A* also indicates the parameter 1.1 which is separated by a comma and, in accordance with the pattern instruction, should be interpreted as a real number for moving the X axle to the position 1.1. The parameter 3.4 which is separated by a comma is also indicated, which parameter should likewise be interpreted as a real number in accordance with the pattern instruction P and indicates that the Y axle should be moved from the instantaneous position by a value of 3.4. The parameters of the machining blocks B* and D* should be interpreted in a corresponding manner.

As a result of the fact that a subprogram generally has a multiplicity of machining blocks which differ only in terms of different parameters but otherwise have the same work instructions, the translation of the subprogram can be considerably simplified. There is no need, for the machining blocks which are defined as belonging to the pattern instruction using the further item of graphical information (“&” in the exemplary embodiment), to convert the ASCII characters of the work instruction, to check the syntax and to check the programming rules of the work instruction, which extremely shortens the computation time. Furthermore, the volume of data in the subprogram itself is also greatly reduced, with the result that, in many applications, it is possible to dispense with downloading the subprogram from the external computer 3 to the memory 10 of the control device 4 while machining the workpiece.

The machining blocks A, B, C and D of the subprogram 2 are conventionally used to generate a respective data record 9, which is associated with the respective machining block and whose structure is illustrated in FIG. 2, for the interpolator 6 of the control device 4 using the interpreter 5. In this case, FIG. 2 illustrates the data record 9 which is generated by the interpreter 5 from the machining block A as the end product of the translation operation. In accordance with the machining block A, the axles to be moved are entered in the first column. The parameters which are associated with the respective axles and are defined in the machining block A are entered in the second column “parameter”. Binary coding is used to define the work instruction for the respective axle in the additional subsequent three columns, a “1” meaning that the corresponding work instruction should be carried out with the parameter for the corresponding axle in the column “parameter”. In this case, as already stated, the designation “ACP” means moving the corresponding axle in the clockwise direction to the position of the parameter, the work instruction “IC” means moving the corresponding axle from a given position by the parameter, and the work instruction “AC” means moving the corresponding axle to the absolute position in accordance with the parameter. The data record 9 is read in by the interpolator 6 and the interpolator 6 uses it to calculate the desired values for the drives 7A, 7B and 7C.

In the method according to the invention, if the interpreter reads in a machining block which is defined as a pattern instruction P by an item of graphical information (in the exemplary embodiment: “DEFPATT”) and contains structure information relating to the data format of subsequent machining blocks A*, B* and D*, the interpreter 6 then generates and stores a form 8 (shown in FIG. 3) having this data format.

FIG. 3 illustrates such a form 8. The form 8 corresponds to the data record 9 shown in FIG. 2 except for the fact that the parameters have not yet been entered in the column “parameter”. The parameters of a subsequent machining block (the machining block A* in this case) which is read in by the interpreter, is defined as belonging to the pattern instruction P by the further item of graphical information “&” and has only parameters (−10.23, 1.1, 3.4) are then entered in the form 8. A data record 9 corresponding to FIG. 2 is generated in such a manner by entering the parameters of the machining block A* in the form 8.

The translation of the work instruction C* remains unaffected by the method according to the invention in accordance with the exemplary embodiment since the work instruction does not have the further item of graphical information “&”. The work instruction C* is therefore translated using the conventional known methods described above with reference to FIG. 2.

If, after the pattern instruction, all subsequent machining blocks in the subprogram are defined, for example by definition until the next pattern instruction, for the previous pattern instruction, definition in the form of a further item of graphical information (“&”) can be dispensed with in the subsequent machining blocks which are to be defined as belonging to the pattern instruction.

Furthermore, it goes without saying that it is also possible to specify, for example, an individual parameter in accordance with the work instruction D** (see example below) as a replacement for a particular parameter which again and again has the same value.

DEFPATT C=ACP(REAL) X(REAL) Y=IC(Real) (P)

&−10.23,1.1,3.4 (A*)

&−20.23,2.1,4.8 (B*)

Y=IC(5.1) (C*)

&−22.23, I,2.9 (D**)

The method according to the invention considerably shortens the translation time for the subprogram since the conversion of the ASCII characters of the machining block, the checking of the syntax of the machining block and the checking of the programming rules of the machining block are largely dispensed with. As a result of the shorter translation time, the method according to the invention enables higher machining speeds of the machine. Furthermore, the quantity of data in the subprogram is also drastically reduced, with the result that, in many cases, it is no longer necessary to store the subprogram in an external computer and the external computer can thus be dispensed with.

1.-5. (canceled)

6. A method for translating a parts program having a plurality of machining instructions by using an interpreter incorporated in a control device which controls at least one of a machine tool, a production machine and a robot, comprising the steps of:
with the interpreter, successively reading the plurality of machining instructions,
detecting with the interpreter a machining instruction defined by graph information as a pattern instruction and containing structural information relating to the data format of subsequent machining instructions,
with the interpreter, generating and storing for a detected record a form having the data format of subsequent machining instructions,
entering in the form the parameters of a subsequent machining instruction read by the interpreter, and
generating from the form and the parameters of the subsequent machining instruction a data record.

7. The method of claim 6, wherein a machining instruction comprises a work instruction and a parameter.

8. The method of claim 6, further comprising the step of entering in the form parameters of a subsequent machining instruction read by the interpreter, wherein the subsequent machining instruction is defined by an additional graph information as belonging to the pattern instruction and includes only parameters.

9. The method of claim 6, wherein a parameter is formed as a special character.

10. A control device for controlling at least one of a machine tool, a production machine and a robot, comprising:
a parts program having a plurality of machining instructions, and
an interpreter successively reading the plurality of machining instructions,
wherein the interpreter is configured to
detect a machining instruction defined by graph information as a pattern instruction and containing structural information relating to the data format of subsequent machining instructions,
generate and store for a detected record a form having the data format of subsequent machining instructions,
enter in the form the parameters of a subsequent machining instruction read by the interpreter, and
generate from the form and the parameters of the subsequent machining instruction a data record.
